(19) United States
(12) Patent Application Publication
(10) Pub. No.: US 2020/0167133 A1
(43) Pub. Date: May 28, 2020

(54) WEB SERVICE MASHUP ORCHESTRATOR

(71) Applicant: SAP SE, Walldorf (DE)

(72) Inventor: Arun Suresh, Bangalore (IN)

(21) Appl. No.: 16/199,764

(22) Filed: Nov. 26, 2018

(51) Int. Cl. G06F 8/34; G06F 8/70; G06F 9/451; H04L 29/08

(52) U.S. Cl. CPC G06F 8/34; H04L 67/34; G06F 9/451; G06F 8/70

(57) ABSTRACT

A user interface is presented that allows a user to select web services to be components of a web service mashup. The user interface allows the user to provide configuration options for one or more of the selected web services. After the web service mashup is defined using the user interface, the web service mashup may be executed using the provided configuration options.

### TECHNICAL FIELD

The subject matter disclosed herein generally relates to web service mashups. Specifically, the present disclosure addresses systems and methods to implement a web service mashup orchestrator.

### BACKGROUND

Some applications are built using microservice architecture. Microservice architecture structures an application as a collection of loosely coupled services. Each service provides specific functionality. These fine-grained services increase the modularity of the application in comparison with monolithic architecture. Different developers can work on different modules simultaneously, increasing the opportunities for parallel development. Furthermore, updates to the services can be released independently, enabling continuous delivery.

To build an application using multiple microservices, a software developer manually sets up a new build pipeline. The build pipeline undergoes standard development and testing efforts.

### BRIEF DESCRIPTION OF THE DRAWINGS

Some embodiments are illustrated by way of example and not limitation in the figures of the accompanying drawings.

FIG. 1 is a network diagram illustrating a network environment suitable for a web service mashup orchestrator, according to some example embodiments.

FIG. 2 is a block diagram of an application server, according to some example embodiments, suitable for providing a web service mashup orchestrator.

FIGS. 3-4 are a block diagram illustrating a database schema suitable for a web service mashup orchestrator, according to some example embodiments.

FIGS. 5-6 are a flowchart illustrating operations of a method suitable for creating a web service mashup via a web service mashup orchestrator, according to some example embodiments.

FIG. 7 is a user interface diagram of a user interface suitable for a web service mashup orchestrator, according to some example embodiments.

FIG. 8 is a user interface diagram of a user interface suitable for a web service mashup orchestrator, according to some example embodiments.

FIG. 9 is a user interface diagram of a user interface suitable for a web service mashup orchestrator, according to some example embodiments.

FIG. 10 is a user interface diagram of a user interface suitable for a web service mashup orchestrator, according to some example embodiments.

FIG. 11 is a user interface diagram of a user interface suitable for a web service mashup orchestrator, according to some example embodiments.

FIG. 12 is a user interface diagram of a user interface suitable for a web service mashup orchestrator, according to some example embodiments.

FIG. 13 is a user interface diagram of a user interface suitable for a web service mashup orchestrator, according to some example embodiments.

FIG. 14 is a block diagram illustrating components of a machine, according to some example embodiments.

### DETAILED DESCRIPTION

Example methods and systems are directed to a web service mashup orchestrator. A web service mashup orchestrator is a computer-implemented tool for creating web service mashups using a graphical user interface. A user interface may be presented that allows a user to select web services to be components of the web service mashup. The user interface may allow the user to provide configuration options for one or more of the selected web services. After the web service mashup is defined using the web service mashup orchestrator, the web service mashup may be executed using the provided configuration options.

By comparison with existing methods of creating web service mashups, in which a developer uses a standard programming language to define the relationships between the component services and to define the configuration options for each component service, the web service mashup orchestrator is less error-prone, faster, and easier to use.

When these effects are considered in aggregate, one or more of the methodologies described herein may obviate a need for certain efforts or resources that otherwise would be involved in creating web service mashups. Computing resources used by one or more machines, databases, or networks may similarly be reduced. Examples of such computing resources include processor cycles, network traffic, memory usage, data storage capacity, power consumption, and cooling capacity.

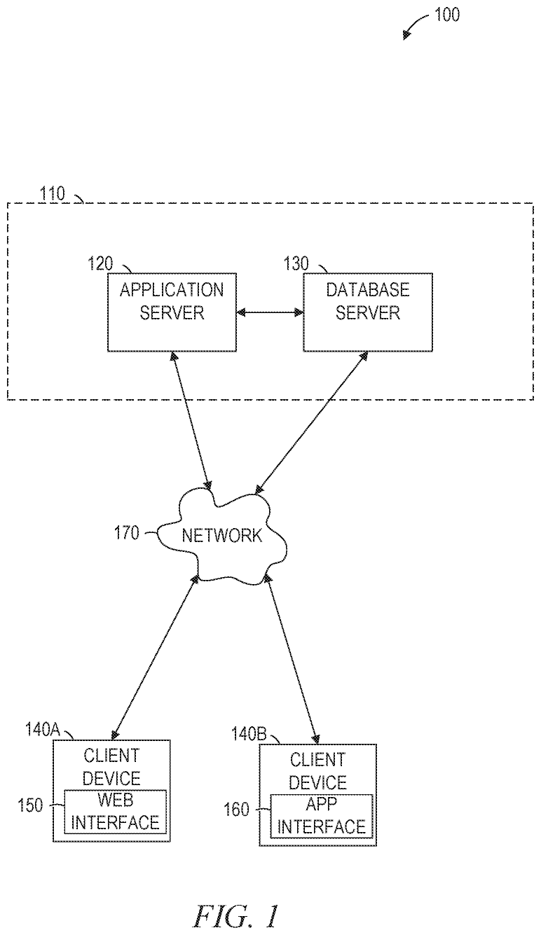

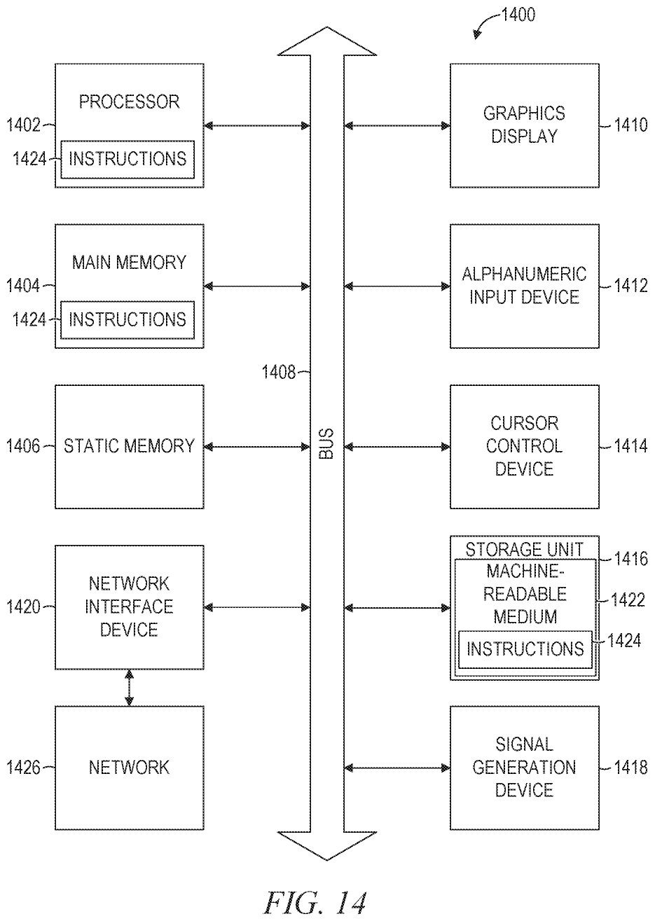

FIG. 1 is a network diagram illustrating a network environment 100 suitable for a web service mashup orchestrator, according to some example embodiments. The network environment 100 includes a network-based application 110, client devices 140A and 140B, and a network 170. The network-based application 110 is provided by an application server 120 in communication with a database server 130. The application server 120 provides an application to the client devices 140A and 140B via a web interface 150 or an application interface 160. The application server 120, the database server 130, and the client devices 140A and 140B may each be implemented in a computer system, in whole or in part, as described below with respect to FIG. 14. The client devices 140A and 140B may be referred to collectively as client devices 140 or generically as a client device 140.

The application server 120 provides a web service mashup orchestrator application to the client devices 140. The application server 120 may also provide one or more services suitable for being used as components in a web service mashup. A web service mashup is an application that uses content from multiple services to create a single new service.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 14. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application server 120, the database server 130, and the client devices 140A-140B may be connected by the network 170. The network 170 may be any network that enables communication between or among machines, databases, and devices. Accordingly, the network 170 may be a wired network, a wireless network (e.g., a mobile or cellular network), or any suitable combination thereof. The network 170 may include one or more portions that constitute a private network, a public network (e.g., the Internet), or any suitable combination thereof.

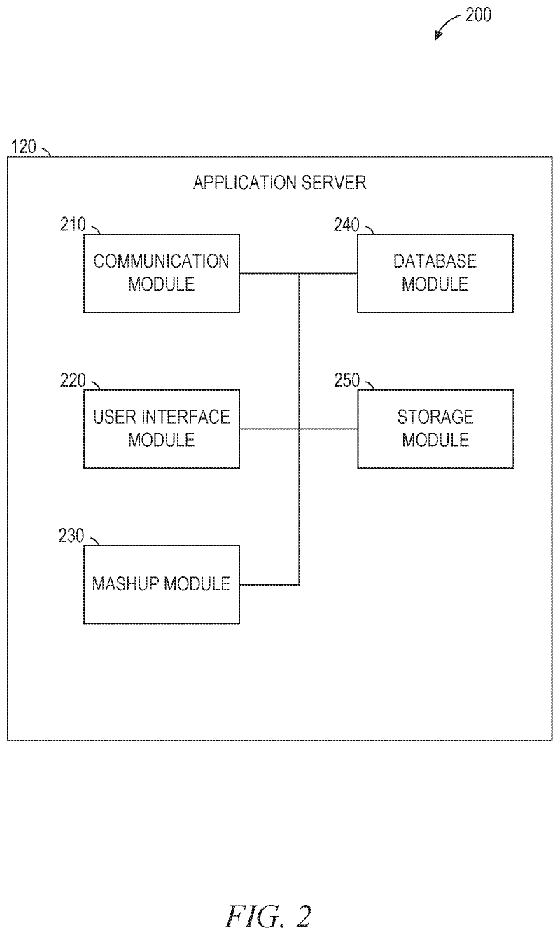

FIG. 2 is a block diagram 200 illustrating components of the application server 120, according to some example embodiments. The application server 120 is shown as including a communication module 210, a user interface module 220, a mashup module 230, a database module 240, and a storage module 250, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 receives data sent to the application server 120 and transmits data from the application server 120. For example, the communication module 210 may receive, from the client device 140A, a query for data regarding services available to be included in a web service mashup. The communication module 210 provides the query to the database module 240. The database module 240 searches a database via the storage module 250 to identify records responsive to the query. The communication module 210 may transmit the responsive data to the client device 140A, provide the responsive data to the user interface module 220 for further processing, or any suitable combination thereof. Communications sent and received by the communication module 210 may be intermediated by the network 170.

The user interface module 220 causes presentation of a user interface for the application server 120 on a display associated with the client device 140A or 140B. The user interface allows a user to view an existing web service mashup, to modify a web service mashup, to create web service mashups, or any suitable combination thereof.

The mashup module 230 receives, via the user interface module 220, selections of microservices to include in a mashup, configuration options for the selected microservices, or both. Based on the received selections and configuration options, the mashup module 230 creates a web service mashup. The mashup module 230 may also invoke the constituent microservices of a web service mashup using the configuration options.

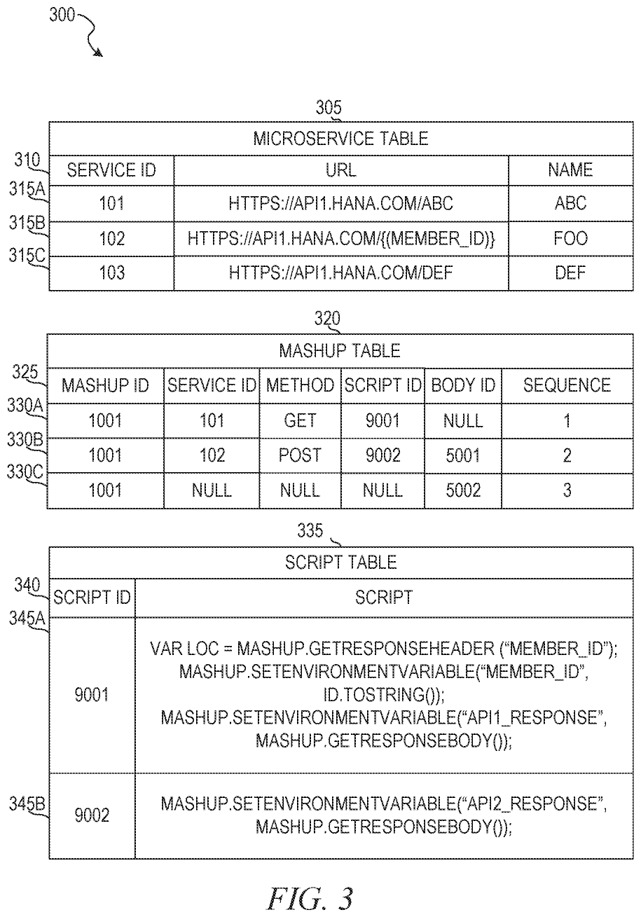

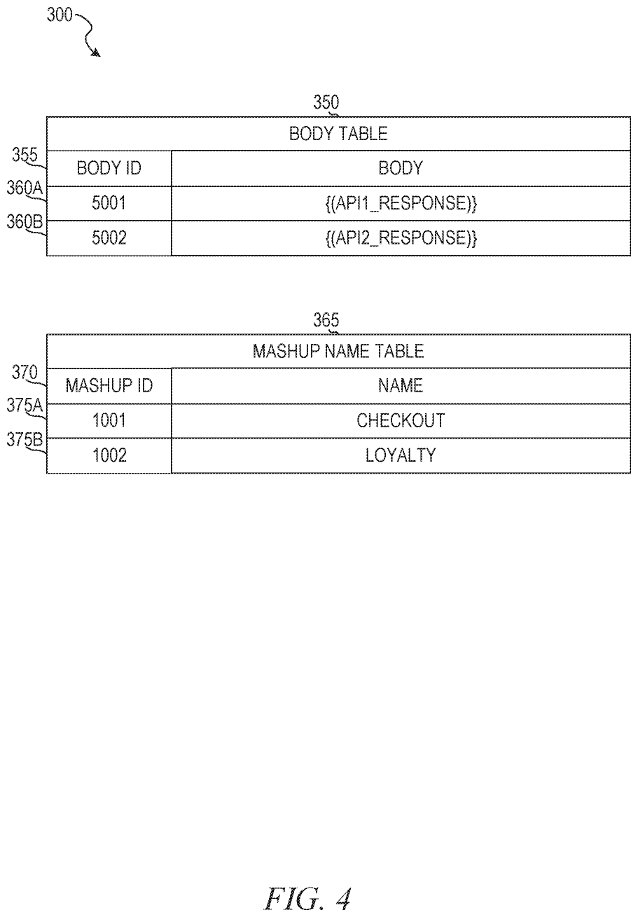

FIGS. 3-4 are a block diagram illustrating a database schema 300 suitable for implementing a web service mashup orchestrator, according to some example embodiments. The database schema 300 includes a microservice table 305, a mashup table 320, a script table 335, a body table 350, and a mashup name table 365. The microservice table 305 has rows 315A, 315B, and 315C of a format 310. Each row of the microservice table 305 stores data for a service that can be included in a web service mashup. The mashup table 320 has rows 330A, 330B, and 330C of a format 325. Each row of the mashup table 320 stores data for an assignment of a microservice to a web service mashup. The script table 335 has rows 345A and 345B of a format 340. Each row of the script table 335 stores data for a script for a web service assigned to a web service mashup. The body table 350 has rows 360A and 360B of a format 355. Each row of the body table 350 stores data for a body for a web service assigned to a web service mashup.

The format 310 of the microservice table 305 includes a service identifier field, a uniform resource locator (URL) field, and a name field. The service identifier field stores a unique identifier for the service of each row. The URL field stores a URL that can be used to invoke the service. The name field stores a human-readable name for the service that can be used in a web service mashup orchestrator user interface.

The format 325 of the mashup table 320 includes a mashup identifier field, a service identifier field, a method field, a script identifier field, a body identifier field, and a sequence field. The mashup identifier field stores a unique identifier for each mashup. Multiple rows in the mashup table 320 having the same mashup identifier contain information for the same mashup. The service identifier field relates a row in the mashup table 320 to a row in the microservice table 305 and identifies the service assigned to the mashup identified by the mashup identifier. The method field indicates the method to be used to pass parameters to the identified service. The script identifier field indicates a row in the script table 335 containing a script to be used when invoking the identified service. The body identifier field indicates a row in the body table 350 containing a body to be used when invoking the identified service. The sequence field indicates the sequence in which services assigned to the same mashup are invoked.

Thus, the row 330A indicates that the service with identifier 101 will be invoked first in the web service mashup having identifier 1001, using the “GET” method, the script from the script table 335 having identifier 9001, and no body (as indicated by the NULL value in the body identifier field). The row 330B indicates that the service with identifier 102 will be invoked second in the same web service mashup, using the “POST” method, the script from the script table 335 having identifier 9002, and the body from the body table 350 having identifier 5001. The row 330C indicates that the third step in the web service mashup having identifier 1001 will provide the body from the body table 350 having identifier 5002 without invoking a service, as indicated by the NULL value in the service identifier field.

The format 340 of the script table 335 includes a script identifier field and a script field. The script identifier field stores an identifier for the script, referenced by the mashup table 320. The script field stores a script to be used when invoking a service.

Each of the rows 360A and 360B stores data in the format 355 comprising a body identifier field and a body field. The body identifier field stores an identifier for the body, referenced by the mashup table 320. The body field stores a body to be used when invoking a service.

The format 370 of the mashup name table 365 includes a mashup identifier field and a name field. The row 375A contains the name “Checkout” for the mashup with identifier 1001. The row 375B contains the name “Loyalty” for the mashup with identifier 1002. Data from the mashup name table 365 may be used to generate user interfaces for manipulating web service mashups.

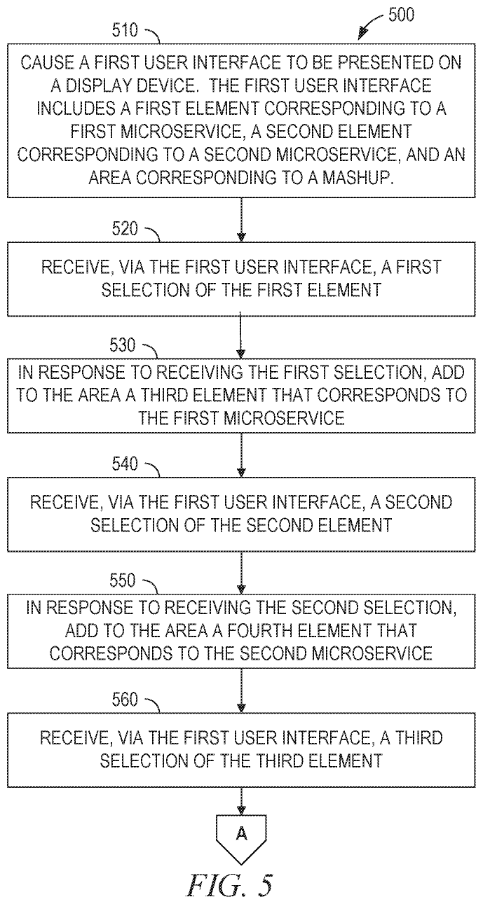

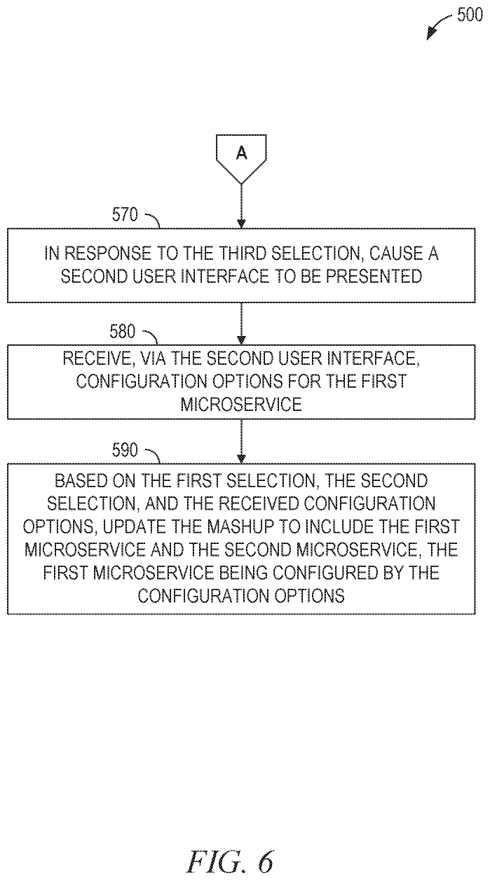

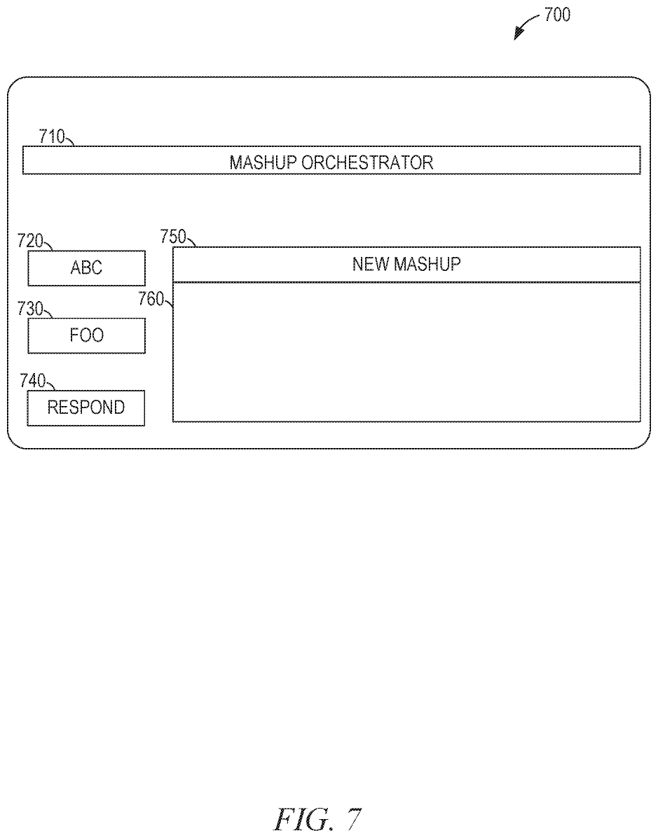

FIGS. 5-6 are a flowchart illustrating operations of a method 500 suitable for creating a web service mashup via a web service mashup orchestrator, according to some example embodiments. The method 500 includes operations 510, 520, 530, 540, 550, 560, 570, 580, and 590. By way of example and not limitation, the method 500 is described as being performed by the devices, modules, and databases of FIGS. 1-4, using the user interfaces of FIGS. 7-10.

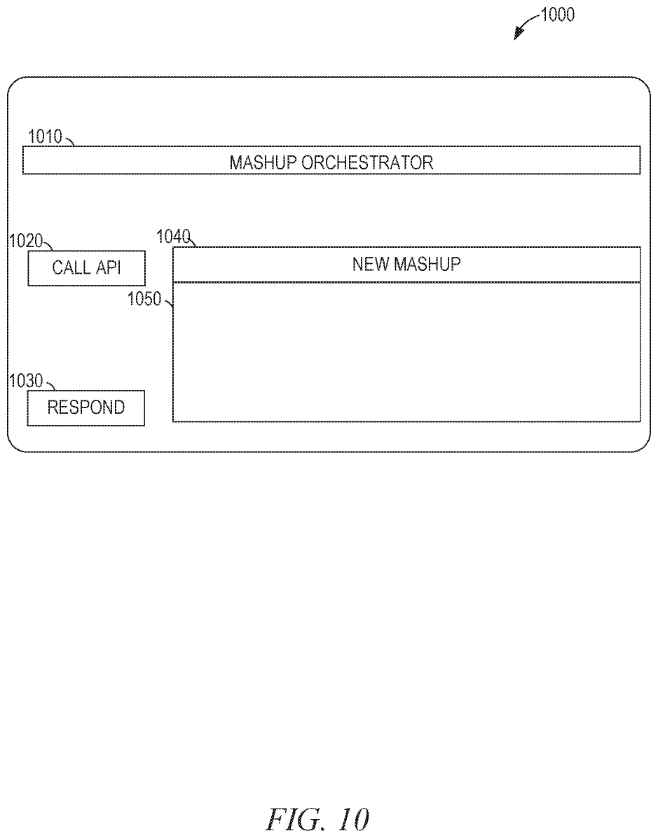

In operation 510, the user interface module 220 causes a first user interface to be presented on a display device (e.g., a screen of the client device 140A). The first user interface includes a first element corresponding to a first microservice, a second element corresponding to a second microservice, and a display area corresponding to a mashup. For example, a user interface 700 (FIG. 7) or a user interface 1000 (FIG. 10) may be displayed.

In operation 520, the mashup module 230 receives, via the first user interface (and the user interface module 220), a first selection of the first element. For example, a web service indicator 720 may be selected.

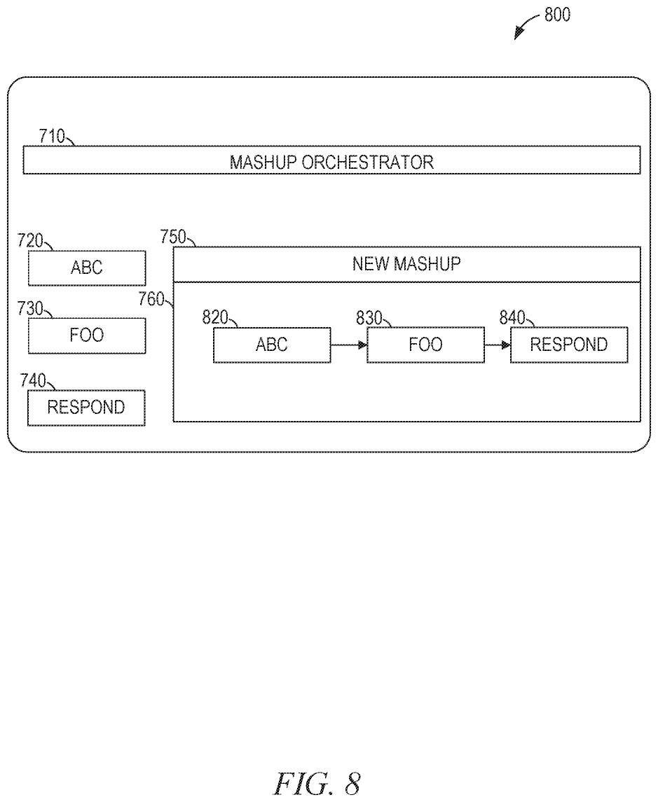

In operation 530, in response to receiving the first selection, the mashup module 230 causes the user interface module 220 to add to the display area a third element that corresponds to the first microservice. For example, a web service indicator 820 of FIG. 8 may be added to a mashup display area 760.

The mashup module 230 receives, via the first user interface, a second selection of the second element (operation 540). For example, a web service indicator 730 may be selected.

In response to receiving the second selection, in operation 550 the mashup module 230 causes the user interface module 220 to add to the display area a fourth element that corresponds to the second microservice. For example, a web service indicator 830 of FIG. 8 may be added to the mashup display area 760.

In operation 560, the mashup module 230 receives, via the first user interface (and the user interface module 220), a third selection of the third element. For example, the web service indicator 820 may be selected.

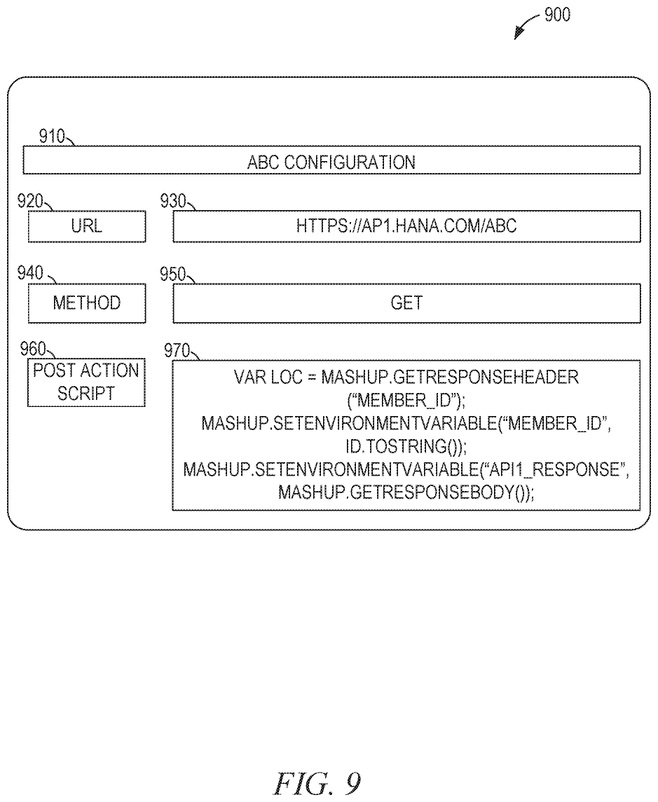

In response to the third selection, the mashup module 230 causes a second user interface to be presented (operation 570). For example, a user interface 900 (FIG. 9) may be presented.

In operation 580, the mashup module 230 receives, via the second user interface, configuration options for the first microservice. In the example of FIG. 9, a URL, a method, and a post-action script are received as configuration options for the microservice of the web service indicator 820.

In operation 590, the mashup module 230, based on the first selection, the second selection, and the received configuration options, updates the mashup to include the first microservice and the second microservice. The first microservice is configured by the configuration options. In some example embodiments, rows in the mashup table 320 are created that indicate the relationship between the two selected microservices and the mashup. The received configuration options may be stored in the microservice table 305, the mashup table 320, the script table 335, the body table 350, other tables, or any suitable combination thereof. By use of the method 500, a web service mashup is created via a graphical user interface.

FIG. 7 is a user interface diagram of a user interface 700 suitable for a web service mashup orchestrator, according to some example embodiments. The user interface 700 includes a title 710, web service indicators 720 and 730, a respond indicator 740, a mashup label 750, and a mashup display area 760.

The title 710 indicates that the user interface 700 is displaying a mashup orchestrator. Each of the web service indicators 720 and 730 identifies a microservice (e.g., by displaying the value of the name field of the microservice table 305 for the microservice). The respond indicator 740 identifies an output function for the mashup. The mashup label 750 indicates that a new mashup is being created. The mashup display area 760 is empty, indicating that no microservices are currently part of the new mashup.

FIG. 8 is a user interface diagram of a user interface 800 suitable for a web service mashup orchestrator, according to some example embodiments. The user interface 800 includes the title 710, the web service indicators 720 and 730, the respond indicator 740, the mashup label 750, the mashup display area 760, and web service indicators 820, 830, and 840 within the mashup display area 760.

The web service indicators 820-840 within the mashup display area 760 indicate that the corresponding web services (ABC, FOO, and RESPOND) are part of the mashup. The arrows connecting the web service indicators 820-840 indicate the sequence in which the corresponding web services will be executed. Thus, when the new mashup is executed, the web service ABC will be run first, followed by the web service FOO, and ending with the web service RESPOND.

The web service indicators 820-840 may have been placed by the mashup module 230 in response to commands received via the user interface 700. For example, a user may have touched or clicked on the web service indicator 720 (for the ABC service) and then touched or clicked on the mashup display area 760 or dragged the web service indicator 720 to the mashup display area 760. The arrows connecting the web service indicators 820-840 may have been automatically placed based on the order in which the web service indicators 820-840 were placed in the mashup display area 760. For example, the indication that the web service ABC is to be performed before the web service FOO may be based on the web service indicator 820 for the web service ABC having been placed in the mashup display area 760 before the web service indicator 830 for the web service FOO. Alternatively or additionally, further user commands may be received that indicate the order in which the web services will be executed in the mashup.

FIG. 9 is a user interface diagram of a user interface 900 suitable for a web service mashup orchestrator, according to some example embodiments. The user interface 900 includes a title 910, configuration field indicators 920, 940, and 960, and configuration entry fields 930, 950, and 970. The title 910 indicates that the user interface 900 is for configuration of the web service ABC. The user interface 900 may be displayed after selection of one of the web service indicators 820-840 (FIG. 8). The selection may take the form of a right-click using a mouse or a long press on a touch screen.

The configuration field indicator 920 indicates that the configuration entry field 930 is for entry of a URL for invoking the web service ABC. The URL for invoking the web service may include one or more parameters (e.g., appended to the URL using a question mark followed by key-value pairs separated by ampersands). In some example embodiments, parameters are received in separate fields.

The configuration field indicator 940 indicates that the configuration entry field 950 is for entry of a method for invoking the web service ABC. The configuration field indicator 960 indicates that the configuration entry field 970 is for entry of a post-action script to be executed after invoking the web service ABC.

One or more of the configuration entry fields 930, 950, and 970 may be text entry fields that receive text typed by a user. Alternatively, one or more of the configuration entry fields 930, 950, and 970 may be a pull-down menu from which the user can select one of a set of predetermined values. For example, the URL and post-action script may be entered using text fields, but the method may be selected from the predetermined values of “GET” and “POST.”

FIG. 10 is a user interface diagram of a user interface 1000 suitable for a web service mashup orchestrator, according to some example embodiments. The user interface 1000 includes a title 1010, web service indicators 1020 and 1030, a mashup label 1040, and a mashup display area 1050. The user interface 1000 is an alternative embodiment of the user interface 700 (FIG. 7).

The title 1010 indicates that the user interface 1000 is displaying a mashup orchestrator. Each of the web service indicators 1020 and 1030 identifies a type of microservice. The mashup label 1040 indicates that a new mashup is being created. The mashup display area 1050 is empty, indicating that no microservices are currently part of the new mashup. The CALL API microservice type of the web service indicator 1020 corresponds to all web services invoked via a URL. The RESPOND microservice type of the web service indicator 1030 does not invoke a web service, but instead provides output from the mashup.

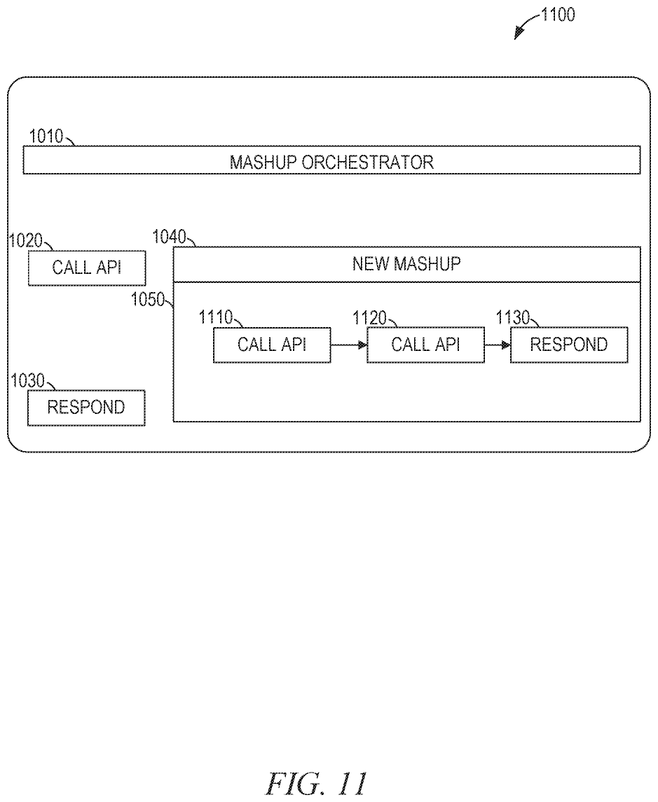

FIG. 11 is a user interface diagram of a user interface 1100 suitable for a web service mashup orchestrator, according to some example embodiments. The user interface 1100 includes the title 1010, the web service indicators 1020 and 1030, the mashup label 1040, and the mashup display area 1050. In addition to the elements shown in the user interface 1000, the user interface 1100 also includes web service indicators 1110, 1120, and 1130 in the mashup display area 1050.

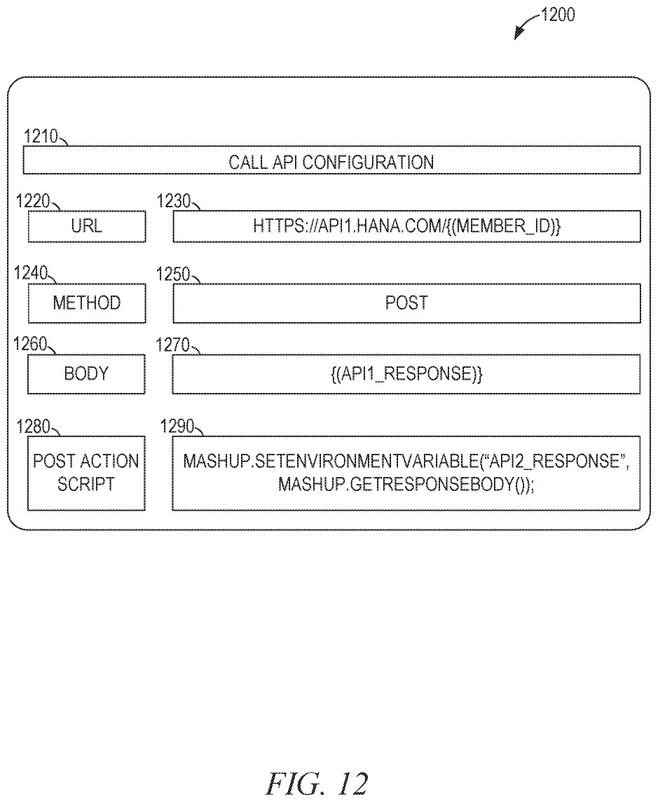

The web service indicators 1110-1130 within the mashup display area 1050 indicate that the corresponding web services (CALL API, CALL API, and RESPOND) are part of the mashup. The arrows connecting the web service indicators 1110-1130 indicate the sequence in which the corresponding web services will be executed. Thus, when the new mashup is executed, the web service CALL API will be run first, followed by a second instance of the web service CALL API, and ending with the web service RESPOND. In the example of FIG. 11, the CALL API service can be used to invoke different web services, depending on the parameters defined for the service (as shown in FIG. 12).

The web service indicators 1110-1130 may have been placed by the mashup module 230 in response to commands received via the user interface 1000. For example, a user may have touched or clicked on the web service indicator 1020 (for the CALL API service) and then touched or clicked on the mashup display area 1050 or dragged the web service indicator 1020 to the mashup display area 1050.

FIG. 12 is a user interface diagram of a user interface 1200 suitable for a web service mashup orchestrator, according to some example embodiments. The user interface 1200 includes a title 1210, configuration field indicators 1220, 1240, 1260, and 1280, and configuration entry fields 1230, 1250, 1270, and 1290. The title 1210 indicates that the user interface 1200 is for configuration of a web service invoked by calling an API. The user interface 1200 may be displayed after selection of one of the web service indicators 1110-1130 (FIG. 11).

The configuration field indicator 1220 indicates that the configuration entry field 1230 is for entry of a URL for invoking a web service. The configuration field indicator 1240 indicates that the configuration entry field 1250 is for entry of a method for invoking the web service. The configuration field indicator 1260 indicates that the configuration entry field 1270 is for entry of a body for the output from the stage in the web service mashup. The configuration field indicator 1280 indicates that the configuration entry field 1290 is for entry of a post-action script to be executed after invoking the web service.

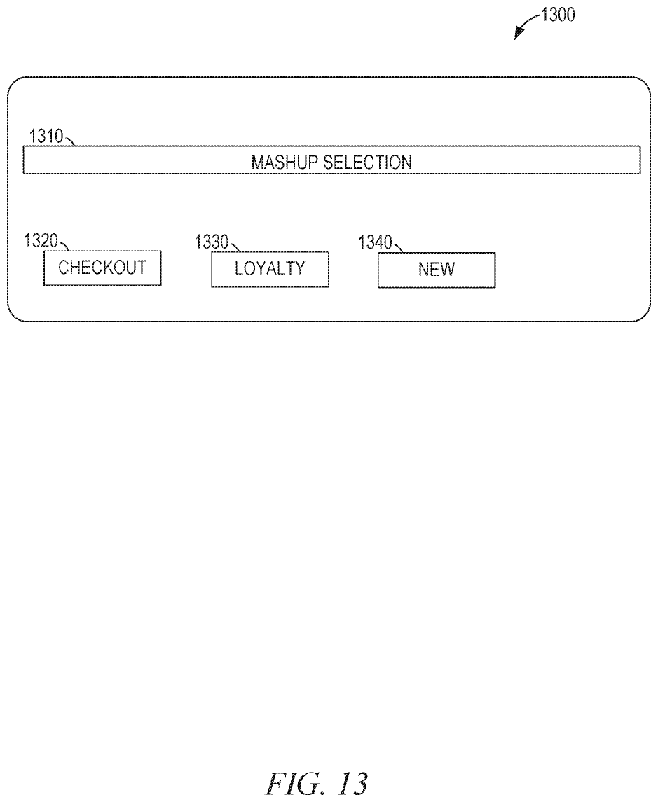

FIG. 13 is a user interface diagram of a user interface 1300 suitable for a web service mashup orchestrator, according to some example embodiments. The user interface 1300 includes a title 1310 and mashup indicators 1320, 1330, and 1340. The user interfaces 700, 800, 1000, and 1100 are described above as being presented for a new mashup, but they can also be used to present existing mashups. The user interface 1300 may be used to select a mashup to present and edit using one or more of the user interfaces 700, 800, 1000, and 1100.

The title 1310 indicates that the user interface 1300 is for selection of a mashup. Each of the mashup indicators 1320 and 1330 is operable to cause selection of a corresponding existing mashup. The text displayed on the mashup indicators 1320 and 1330 may be retrieved from the mashup name table 365 (FIG. 3). Selection of one of the mashup indicators 1320 or 1330 may cause an identifier for the mashup (e.g., the text displayed on the mashup indicator or the corresponding mashup identifier from the mashup name table 365) to be sent from a client device 140 to the application server 120. In response to receiving the mashup identifier, the application server 120 may cause presentation of one of the user interfaces 700, 800, 1000, or 1100, wherein the name of the mashup (e.g., the mashup label 750 of FIG. 7) is replaced by the name of the selected mashup and the contents of the mashup display area (e.g., the mashup display area 760 of FIG. 7) are replaced by the current contents of the selected mashup. The mashup indicator 1340 is operable to cause the creation of a new mashup, as shown in the user interfaces 700, 800, 1000, and 1100. Selection of the mashup indicator 1340 may be indicated to the application server 120 by sending a NULL mashup identifier.

### EXAMPLES

### Example 1

A method comprising:

causing, by one or more processors, a first user interface to be presented on a display device, the first user interface including:
a first element corresponding to a first microservice;
a second element corresponding to a second microservice; and
a display area corresponding to a mashup;
receiving, via the first user interface, a first selection of the first element;
in response to the first selection, adding a third element to the display area, the third element corresponding to the first microservice;
receiving, via the first user interface, a second selection of the second element;
in response to the second selection, adding a fourth element to the display area, the fourth element corresponding to the second microservice;
receiving, via the first user interface, a third selection of the third element;
in response to the third selection, causing a second user interface to be presented on the display device;
receiving, via the second user interface, configuration options for the first microservice; and
based on the first selection, the second selection, and the received configuration options, updating the mashup to include the first microservice and the second microservice, the first microservice being configured by the configuration options.

### Example 2

The method of example 1, further comprising: prior to causing the first user interface to be presented, receiving a parameter that identifies the mashup.

### Example 3

The method of example 1 or example 2, wherein the receiving of the second selection comprises receiving an indication that the second microservice is to be executed after the first microservice in the mashup.

### Example 4

The method of example 3, wherein the updating of the mashup comprises, based on the receiving of the indication, updating the mashup so that the second microservice is executed after the first microservice in the mashup.

### Example 5

The method of any of examples 1 to 4, wherein the receiving of the configuration options comprises receiving a uniform resource locator (URL).

### Example 6

The method of any of examples 1 to 5, wherein the receiving of the configuration options comprises receiving a script.

### Example 7

The method of any of examples 1 to 6, wherein the receiving of the configuration options comprises receiving a parameter.

### Example 8

The method of any of examples 1 to 7, wherein the receiving of the third selection of the third element comprises receiving a long touch or a right click.

### Example 9

A system comprising:

a memory that stores instructions; and
one or more processors configured by the instructions to perform operations comprising:
causing a first user interface to be presented on a display device, the first user interface including:
a first element corresponding to a first microservice;
a second element corresponding to a second microservice; and
a display area corresponding to a mashup;
receiving, via the first user interface, a first selection of the first element;
in response to the first selection, adding a third element to the display area, the third element corresponding to the first microservice;
receiving, via the first user interface, a second selection of the second element;
in response to the second selection, adding a fourth element to the display area, the fourth element corresponding to the second microservice;
receiving, via the first user interface, a third selection of the third element;
in response to the third selection, causing a second user interface to be presented on the display device;
receiving, via the second user interface, configuration options for the first microservice; and
based on the first selection, the second selection, and the received configuration options, updating the mashup to include the first microservice and the second microservice, the first microservice being configured by the configuration options.

### Example 10

The system of example 9, wherein the operations further comprise:

prior to causing the first user interface to be presented, receiving a parameter that identifies the mashup.

### Example 11

The system of example 9 or example 10, wherein the receiving of the second selection comprises receiving an indication that the second microservice is to be executed after the first microservice in the mashup.

### Example 12

The system of example 11, wherein the updating of the mashup comprises, based on the receiving of the indication, updating the mashup so that the second microservice is executed after the first microservice in the mashup.

### Example 13

The system of any of examples 9 to 12, wherein the receiving of the configuration options comprises receiving a uniform resource locator (URL).

### Example 14

The system of any of examples 9 to 13, wherein the receiving of the configuration options comprises receiving a script.

### Example 15

The system of any of examples 9 to 14, wherein the receiving of the configuration options comprises receiving a parameter.

### Example 16

The system of any of examples 9 to 15, wherein the receiving of the third selection of the third element comprises receiving a long touch or a right click.

### Example 17

A non-transitory computer-readable medium that stores instructions that, when executed by one or more processors, cause the one or more processors to perform operations comprising:

causing a first user interface to be presented on a display device, the first user interface including:
a first element corresponding to a first microservice;
a second element corresponding to a second microservice; and
a display area corresponding to a mashup;
receiving, via the first user interface, a first selection of the first element;
in response to the first selection, adding a third element to the display area, the third element corresponding to the first microservice;
receiving, via the first user interface, a second selection of the second element;
in response to the second selection, adding a fourth element to the display area, the fourth element corresponding to the second microservice;
receiving, via the first user interface, a third selection of the third element;
in response to the third selection, causing a second user interface to be presented on the display device;
receiving, via the second user interface, configuration options for the first microservice; and
based on the first selection, the second selection, and the received configuration options, updating the mashup to include the first microservice and the second microservice, the first microservice being configured by the configuration options.

### Example 18

The computer-readable medium of example 17, wherein the operations further comprise: prior to causing the first user interface to be presented, receiving a parameter that identifies the mashup.

### Example 19

The computer-readable medium of example 17 or example 18, wherein the receiving of the second selection comprises receiving an indication that the second microservice is to be executed after the first microservice in the mashup.

### Example 20

The computer-readable medium of example 19, wherein the updating of the mashup comprises, based on the receiving of the indication, updating the mashup so that the second microservice is executed after the first microservice in the mashup.

FIG. 14 is a block diagram illustrating components of a machine 1400, according to some example embodiments, able to read instructions from a machine-readable medium (e.g., a machine-readable storage medium, a computer-readable storage medium, or any suitable combination thereof) and perform any one or more of the methodologies discussed herein, in whole or in part. Specifically, FIG. 14 shows a diagrammatic representation of the machine 1400 in the example form of a computer system within which instructions 1424 (e.g., software, a program, an application, an applet, an app, or other executable code) for causing the machine 1400 to perform any one or more of the methodologies discussed herein may be executed, in whole or in part. In alternative embodiments, the machine 1400 operates as a standalone device or may be connected (e.g., networked) to other machines. In a networked deployment, the machine 1400 may operate in the capacity of a server machine or a client machine in a server-client network environment, or as a peer machine in a distributed (e.g., peer-to-peer) network environment. The machine 1400 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1424, sequentially or otherwise, that specify actions to be taken by that machine. Further, while only a single machine is illustrated, the term “machine” shall also be taken to include a collection of machines that individually or jointly execute the instructions 1424 to perform all or part of any one or more of the methodologies discussed herein.

The machine 1400 includes a processor 1402 (e.g., a central processing unit (CPU), a graphics processing unit (GPU), a digital signal processor (DSP), an application-specific integrated circuit (ASIC), a radio-frequency integrated circuit (RFIC), or any suitable combination thereof), a main memory 1404, and a static memory 1406, which are configured to communicate with each other via a bus 1408. The machine 1400 may further include a graphics display 1410 (e.g., a plasma display panel (PDP), a light-emitting diode (LED) display, a liquid crystal display (LCD), a projector, or a cathode ray tube (CRT)). The machine 1400 may also include an alphanumeric input device 1412 (e.g., a keyboard), a cursor control device 1414 (e.g., a mouse, a touchpad, a trackball, a joystick, a motion sensor, or another pointing instrument), a storage unit 1416, a signal generation device 1418 (e.g., a speaker), and a network interface device 1420.

The storage unit 1416 includes a machine-readable medium 1422 on which are stored the instructions 1424 embodying any one or more of the methodologies or functions described herein. The instructions 1424 may also reside, completely or at least partially, within the main memory 1404, within the processor 1402 (e.g., within the processor's cache memory), or both, during execution thereof by the machine 1400. Accordingly, the main memory 1404 and the processor 1402 may be considered as machine-readable media. The instructions 1424 may be transmitted or received over a network 1426 via the network interface device 1420.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1422 is shown, in an example embodiment, to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., the machine 1400), such that the instructions, when executed by one or more processors of the machine (e.g., the processor 1402), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field-programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application programming interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
causing, by one or more processors, a first user interface to be presented on a display device, the first user interface including:
a first element corresponding to a first microservice;
a second element corresponding to a second microservice; and
a display area corresponding to a mashup;
receiving, via the first user interface, a first selection of the first element;
in response to the first selection, adding a third element to the display area, the third element corresponding to the first microservice;
receiving, via the first user interface, a second selection of the second element;
in response to the second selection, adding a fourth element to the display area, the fourth element corresponding to the second microservice;
receiving, via the first user interface, a third selection of the third element;
in response to the third selection, causing a second user interface to be presented on the display device,
receiving, via the second user interface, configuration options for the first microservice; and
based on the first selection, the second selection, and the received configuration options, updating the mashup to include the first microservice and the second microservice, the first microservice being configured by the configuration options.

2. The method of claim 1, further comprising:
prior to causing the first user interface to be presented, receiving a parameter that identifies the mashup.

3. The method of claim 1, wherein the receiving of the second selection comprises receiving an indication that the second microservice is to be executed after the first microservice in the mashup.

4. The method of claim 3, wherein the updating of the mashup comprises, based on the receiving of the indication, updating the mashup so that the second microservice is executed after the first microservice in the mashup.

5. The method of claim 1, wherein the receiving of the configuration options comprises receiving a uniform resource locator (URL).

6. The method of claim 1, wherein the receiving of the configuration options comprises receiving a script.

7. The method of claim 1, wherein the receiving of the configuration options comprises receiving a parameter.

8. The method of claim 1, wherein the receiving of the third selection of the third element comprises receiving a long touch or a right click.

9. A system comprising:
a memory that stores instructions; and
one or more processors configured by the instructions to perform operations comprising:
causing a first user interface to be presented on a display device, the first user interface including:
a first element corresponding to a first microservice;
a second element corresponding to a second microservice; and
a display area corresponding to a mashup;
receiving, via the first user interface, a first selection of the first element;
in response to the first selection, adding a third element to the display area, the third element corresponding to the first microservice;
receiving, via the first user interface, a second selection of the second element;
in response to the second selection, adding a fourth element to the display area, the fourth element corresponding to the second microservice;
receiving, via the first user interface, a third selection of the third element;
in response to the third selection, causing a second user interface to be presented on the display device;
receiving, via the second user interface, configuration options for the first microservice; and
based on the first selection, the second selection, and the received configuration options, updating the mashup to include the first microservice and the second microservice, the first microservice being configured by the configuration options.

10. The system of claim 9, wherein the operations further comprise:
prior to causing the first user interface to be presented, receiving a parameter that identifies the mashup.

11. The system of claim 9, wherein the receiving of the second selection comprises receiving an indication that the second microservice is to be executed after the first microservice in the mashup.

12. The system of claim 11, wherein the updating of the mashup comprises, based on the receiving of the indication, updating the mashup so that the second microservice is executed after the first microservice in the mashup.

13. The system of claim 9, wherein the receiving of the configuration options comprises receiving a uniform resource locator (URL).

14. The system of claim 9, wherein the receiving of the configuration options comprises receiving a script.

15. The system of claim 9, wherein the receiving of the configuration options comprises receiving a parameter.

16. The system of claim 9, wherein the receiving of the third selection of the third element comprises receiving a long touch or a right click.

17. A non-transitory computer-readable medium that stores instructions that, when executed by one or more processors, cause the one or more processors to perform operations comprising:
causing a first user interface to be presented on a display device, the first user interface including:
a first element corresponding to a first microservice;
a second element corresponding to a second microservice; and
a display area corresponding to a mashup;
receiving, via the first user interface, a first selection of the first element;
in response to the first selection, adding a third element to the display area, the third element corresponding to the first microservice;
receiving, via the first user interface, a second selection of the second element;
in response to the second selection, adding a fourth element to the display area, the fourth element corresponding to the second microservice;
receiving, via the first user interface, a third selection of the third element;
in response to the third selection, causing a second user interface to be presented on the display device;
receiving, via the second user interface, configuration options for the first microservice; and
based on the first selection, the second selection, and the received configuration options, updating the mashup to include the first microservice and the second microservice, the first microservice being configured by the configuration options.

18. The computer-readable medium of claim 17, wherein the operations further comprise:
prior to causing the first user interface to be presented, receiving a parameter that identifies the mashup.

19. The computer-readable medium of claim 17, wherein the receiving of the second selection comprises receiving an indication that the second microservice is to be executed after the first microservice in the mashup.

20. The computer-readable medium of claim 19, wherein the updating of the mashup comprises, based on the receiving of the indication, updating the mashup so that the second microservice is executed after the first microservice in the mashup.
